(19) United States
(12) Patent Application Publication
(10) Pub. No.: US 2018/0167127 A1
(43) Pub. Date: Jun. 14, 2018

(54) COMMUNICATION CONTROL DEVICE AND PHASE ADJUSTING METHOD

(71) Applicant: FUJITSU LIMITED, Kawasaki-shi (JP)

(72) Inventors: Kazuyuki Ozaki, Yokohama (JP); Shunsuke FUJIO, Kawasaki (JP)

(73) Assignee: FUJITSU LIMITED, Kawasaki-shi (JP)

(21) Appl. No.: 15/794,350

(22) Filed: Oct. 26, 2017

(30) Foreign Application Priority Data
Dec. 13, 2016 (JP) 2016-241653

(51) Int. Cl. H04B 7/06; H04W 16/28

(52) U.S. Cl. CPC H04B 7/0691; H04W 72/046; H04W 16/28

(57) ABSTRACT

A communication control device includes: a beam forming unit that forms a beam by controlling a phase of a transmission signal that is transmitted through each of a plurality of antennas; a phase adjusting unit that applies phase rotation to the transmission signal to compensate for a phase shift at each frequency of the transmission signal, whose phase is controlled by the beam forming unit, the phase shift corresponding to a signal bandwidth of the transmission signal; and a control unit that controls the phase rotation that is applied to the transmission signal by the phase adjusting unit.

### CROSS-REFERENCE TO RELATED APPLICATION

This application is based upon and claims the benefit of priority of the prior Japanese Patent Application No. 2016-241653, filed on Dec. 13, 2016, the entire contents of which are incorporated herein by reference.

### FIELD

The embodiments discussed herein are related to a communication control device and a phase adjusting method.

### BACKGROUND

In recent years, there has been an increasing demand for ultrahigh-speed transmission in wireless communication systems. As a way of achieving ultrahigh-speed transmission, the use of high-frequency and wide-band signals is possible. For example, in Institute of Electrical and Electronics Engineers (IEEE) 802.11ad, IEEE 802.11ay, or the like, there are international standards for performing communications by using frequencies in the band of 60 GHz, which is higher than microwaves. It is generally considered that, if communications are performed by using such a high frequency band, propagation loss is large. Thus, one of the technologies for compensating for propagation loss is, for example, beamforming that controls a beam by using multiple antennas to improve antenna gain.

Beamforming includes a full-digital type for controlling a beam direction in a digital area by individually installing a digital analog converter (DAC) for all the antennas and a full-analog type for controlling a beam direction by using a phase shifter for each antenna by installing a common DAC for all the antennas. Furthermore, there is a hybrid type for controlling a beam direction in combination of the digital type and the analog type. Each type of beamforming has advantages and disadvantages; however, in terms of performance and power consumption, the hybrid type is typically used.
[Patent Literature 1] Japanese National Publication of International Patent Application No. 2014-527754
[Patent Literature 2] Japanese Laid-open Patent Publication No. 7-321536
[Non Patent Literature 1] Bhaba P. Das et al., “Voltage Controlled Tunable All Pass Filter Using LM 13700 Operational Transconductance Amplifier”, ISSSE2010, 2010
[Non Patent Literature 2] IEEE Std 802.11ad, “Part 11: Wireless LAN Medium Access Control (MAC) and Physical Layer (PHY) Specifications Amendment 3: Enhancements for Very High Throughput in the 60 GHz Band”, IEEE, December, 2012
[Non Patent Literature 3] T. Kim et al., “Tens of Gbps Support with mmWave Beamforming Systems for Next Generation Communications”, Globecom2013, December, 2013

However, if hybrid-type beamforming is applied to transmission of signals in a high-frequency band, such as millimeter waves, there is a problem in that a beam direction is shifted between the center frequency in the band and a frequency in the edge of the band because of a wide bandwidth of the signal. In other words, there is a problem in that it is difficult to conduct the optimum beam control in the entire band of signal.

Specifically, the phase ϕₙ of the nth antenna may be calculated by using the following Equation (1), where for example the carrier wave frequency is f₀, the beam direction is θ₀, and the adjacent-antenna interval is d.

$${φ}_{n} = \frac{2 π}{c} {f}_{0} nd sin {θ}_{0} \qquad ( 1 )$$

In Equation (1), c denotes a light velocity (m/s). On the basis of Equation (1), the phase shift Δϕₙ(f) of the nth antenna is calculated with regard to the frequency (f₀+f), which is located away from the carrier wave frequency f₀ by the frequency width f, and the carrier wave frequency f₀ according to the following Equation (2).

$$\begin{matrix}Δ {φ}_{n} ( f ) = \frac{2 π}{c} ( {f}_{0} + f ) nd sin {θ}_{0} - \frac{2 π}{c} {f}_{0} nd sin {θ}_{0} \\ = \frac{2 π f nd}{c} sin {θ}_{0}\end{matrix} \qquad ( 2 )$$

As it is understood from Equation (2), if the frequency width f from the carrier wave frequency f₀ is sufficiently smaller than the light velocity c (f<<c), the phase shift Δϕₙ(f) of each antenna is negligibly small. However, if the bandwidth of a signal is wide, the frequency width f between the carrier wave frequency f₀ and a frequency at the edge of the signal bandwidth is large; therefore, the phase shift Δϕₙ(f) is increased, and the direction of a beam differs at the carrier wave frequency f₀ and at the frequency in the edge of the band. As a result, the communication quality deteriorates at the frequency in the band edge of the signal.

FIG. 6 is a diagram that illustrates a specific example of a beam direction between adjacent antennas if the carrier wave frequency, which is the center frequency of a transmission signal, is 60 GHz. In FIG. 6, a curved line 10 indicates an angle difference of the beam direction between the center frequency and the frequency in the band edge if the bandwidth is 1 GHz, and a curved line 20 indicates an angle difference of the beam direction between the center frequency and the frequency in the band edge if the bandwidth is 2 GHz. In the same manner, curved lines 30, 40, and 50 indicate an angle difference of the beam direction between the center frequency and the frequency in the band edge if the bandwidth is 4 GHz, 6 GHz, and 8 GHz, respectively.

As it is understood from FIG. 6, as the signal bandwidth is wider, the beam direction at the frequency in the band edge is shifted from the beam direction at the center frequency. For example, in a case where the beam direction at the center frequency is at 60 degrees (or −60 degrees), the angle difference of the beam direction is about 0.8 degrees if the signal bandwidth is 1 GHz (the curved line 10), meanwhile the angle difference of the beam direction is about 5.6 degrees if the signal bandwidth is 8 GHz (the curved line 50). Thus, if the signal bandwidth is wide, the beam direction is shifted in accordance with a frequency due to a phase shift between the center frequency and the frequency in the band edge, which causes degradations in the communication quality of the entire signal.

### SUMMARY

According to an aspect of an embodiment, a communication control device includes: a beam forming unit that forms a beam by controlling a phase of a transmission signal that is transmitted through each of a plurality of antennas; a phase adjusting unit that applies phase rotation to the transmission signal to compensate for a phase shift at each frequency of the transmission signal, whose phase is controlled by the beam forming unit, the phase shift corresponding to a signal bandwidth of the transmission signal; and a control unit that controls the phase rotation that is applied to the transmission signal by the phase adjusting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram that illustrates a configuration of a base station device according to a first embodiment;

FIG. 2 is a block diagram that illustrates a configuration of a transmission section of the base station device according to the first embodiment;

FIG. 3 is a flowchart that illustrates a phase adjusting method according to the first embodiment;

FIG. 4 is a block diagram that illustrates a configuration of a transmission section of the base station device according to a second embodiment;

FIG. 5 is a flowchart that illustrates a phase adjusting method according to the second embodiment; and

FIG. 6 is a diagram that illustrates a specific example of the beam direction at each signal bandwidth.

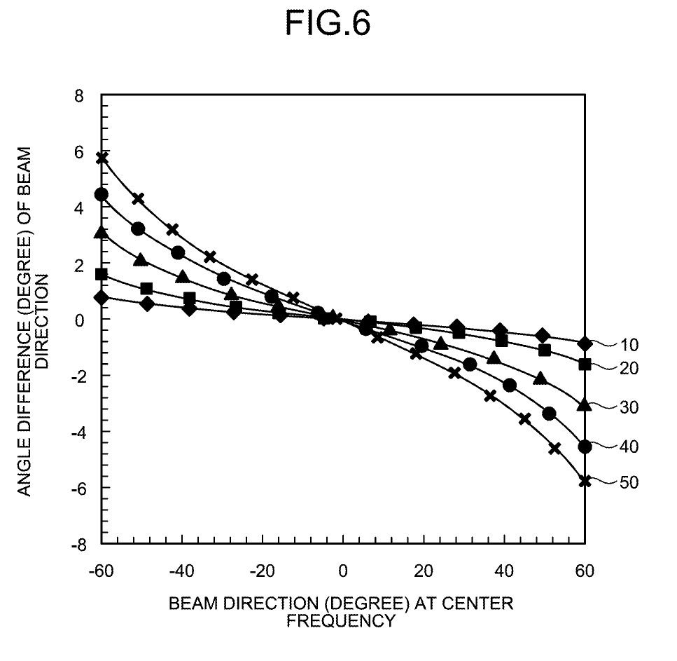

### DESCRIPTION OF EMBODIMENTS

Preferred embodiments of the present invention will be explained with reference to accompanying drawings. Furthermore, the present invention is not limited to the embodiments.

### [a] First Embodiment

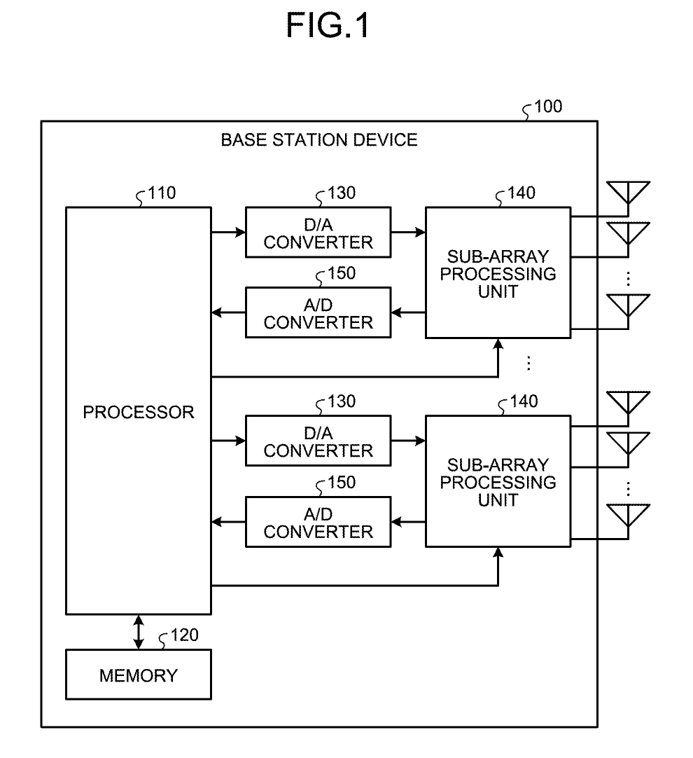

FIG. 1 is a block diagram that illustrates a configuration of a base station device 100 according to a first embodiment. The base station device 100, illustrated in FIG. 1, includes a processor 110, a memory 120, a digital/analog (D/A) converter 130, a sub-array processing unit 140, and an analog/digital (A/D) converter 150. Furthermore, the base station device 100 includes multiple antennas, and the antennas are divided into groups that are called sub arrays. Specifically, the base station device 100 includes multiple sub arrays that each include multiple antennas and, for each sub array, includes the D/A converter 130, the sub-array processing unit 140, and the A/D converter 150.

The processor 110 includes, for example, a central processing unit (CPU), a field programmable gate array (FPGA), or a digital signal processor (DSP), and it performs overall control on the base station device 100 in an integrated manner. For example, the processor 110 determines the beam direction of a transmission signal and applies a weight to the transmission signal in accordance with the determined beam direction. Furthermore, the processor 110 determines the phase value of each antenna in the sub-array processing unit 140 and sets the determined phase value in a phase shifter for each antenna. Specific function and operation of the processor 110 are described in detail later.

The memory 120 includes, for example, a random access memory (RAM) or a read only memory (ROM), and it stores various types of information when the processor 110 performs processes.

The D/A converter 130 conducts D/A conversion on a transmission signal for each sub array. Furthermore, it is assumed here that a signal of each sub array is a signal that is addressed to one user terminal device. Specifically, the processor 110 assigns a signal for each user terminal device to each sub array and outputs a transmission signal for each user terminal device to the D/A converter 130 of each sub array. Therefore, the D/A converter 130 conducts D/A conversion on a transmission signal for each user terminal device.

The sub-array processing unit 140 transmits a transmission signal for each sub array via multiple antennas that belong to each sub array. Here, the sub-array processing unit 140 uses a phase shifter, provided for each antenna, to change the phase of a signal for each antenna, thereby controlling a beam direction. Furthermore, the sub-array processing unit 140 receives signals from a user terminal device via multiple antennas that belong to a sub array and outputs the received signals to the A/D converter 150. Specific configuration and operation of the sub-array processing unit 140 are described in detail later.

The A/D converter 150 conducts A/D conversion on reception signals that are output from the sub-array processing unit 140. Then, the A/D converter 150 outputs reception signals, which have been converted into digital signals, to the processor 110.

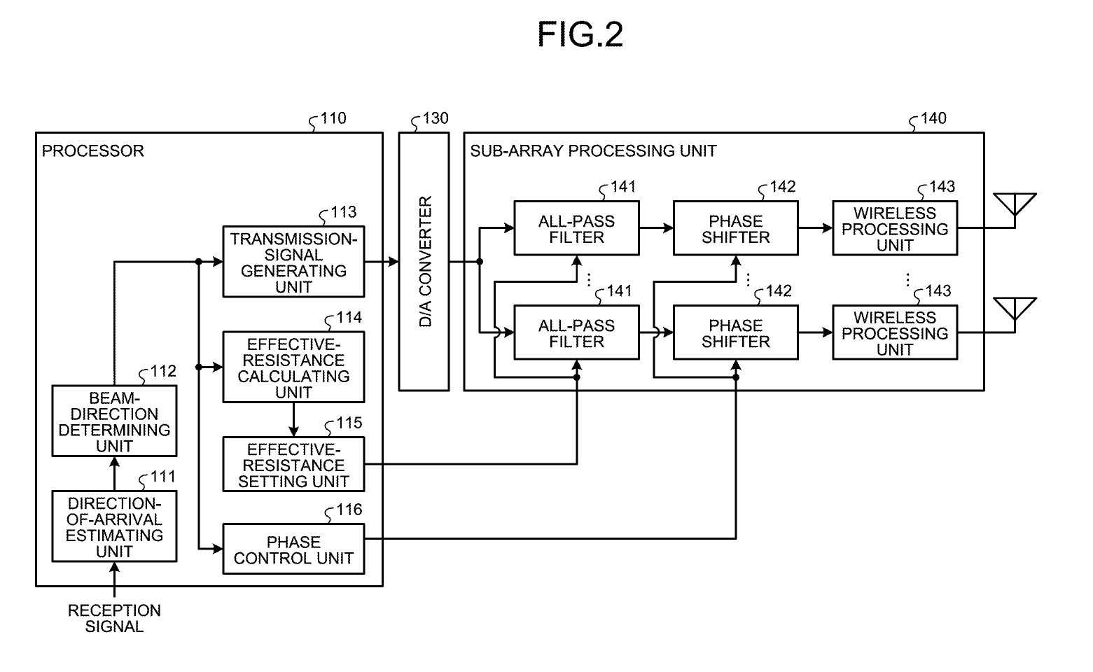

FIG. 2 is a block diagram that illustrates a configuration of a transmission section of the base station device 100 according to the first embodiment. FIG. 2 illustrates a configuration with regard to transmission in the processor 110 and the single sub-array processing unit 140. As illustrated in FIG. 2, the processor 110 includes a direction-of-arrival estimating unit 111, a beam-direction determining unit 112, a transmission-signal generating unit 113, an effective-resistance calculating unit 114, an effective-resistance setting unit 115, and a phase control unit 116. Furthermore, the sub-array processing unit 140 includes an all-pass filter 141, a phase shifter 142, and a wireless processing unit 143, which correspond to each of the antennas.

The direction-of-arrival estimating unit 111 uses a reception signal, output from the A/D converter 150, to estimate an arrival direction of the reception signal. That is, the direction-of-arrival estimating unit 111 estimates the direction of the user terminal device, which is the transmission source of the signal. Specifically, the direction-of-arrival estimating unit 111 changes the beam direction by for example changing the phase value that is set in the phase shifter 142 of the single sub-array processing unit 140 and estimates that the direction of the user terminal device is the beam direction with the maximum reception power.

The beam-direction determining unit 112 determines the beam direction for transmitting signals on the basis of the direction of the user terminal device, estimated by the direction-of-arrival estimating unit 111. Specifically, the beam-direction determining unit 112 determines the beam direction so as to increase the gain in the direction of the user terminal device, which is the transmission destination of a signal. Here, the beam-direction determining unit 112 regards, for example, the direction perpendicular to the direction in which each antenna of a sub array is arranged as 0 degree and determines an angle in the beam direction with reference to the direction.

The transmission-signal generating unit 113 generates a transmission signal that is addressed to the user terminal device and multiplies the transmission signal by the weight that corresponds to the beam direction that is determined by the beam-direction determining unit 112. Specifically, the transmission-signal generating unit 113 applies a weight to a transmission signal through digital-type beamforming. As the carrier wave of signals transmitted by the base station device 100 has a high frequency and a wide band, transmission signals generated by the transmission-signal generating unit 113 are also wideband signals.

The effective-resistance calculating unit 114 calculates an effective resistance that is set in each of the all-pass filters 141 in the sub-array processing unit 140 on the basis of the beam direction that is determined by the beam-direction determining unit 112. Specifically, the effective-resistance calculating unit 114 uses the following Equation (3) to calculate the effective resistance R_{eff,n} that is set in the all-pass filter 141 that is provided in relation to the nth antenna.

$${R}_{eff , n} = \frac{1}{π BWC} tan ( \frac{π BW nd}{2 c} sin {θ}_{0} ) \qquad ( 3 )$$

Here, in Equation (3), BW denotes the signal bandwidth, and C denotes the capacitance of the all-pass filter 141. Furthermore, d denotes the adjacent-antenna interval in a sub array, c denotes a light velocity, and θ₀ denotes an angle in the beam direction. In this way, for each antenna in a sub array, the effective-resistance calculating unit 114 calculates the effective resistance R_{eff,n} that changes in accordance with the signal bandwidth BW and the beam direction θ₀.

Here, the effective resistance of the all-pass filter 141 corresponds to the phase rotation degree of the all-pass filter 141. That is, the phase rotation degree of the all-pass filter 141 may be controlled by changing the effective resistance of the all-pass filter 141. Specifically, the following Equation (4) represents the phase rotation degree Δθₙ(f) of a signal at the frequency f in the all-pass filter 141 that corresponds to the nth antenna.

Δθₙ(f)=−2 arctan(2πfR_{eff,n}C) (4)

Here, in Equation (4) as is the case with the above Equation (3), R_{eff,n} denotes the effective resistance, and C denotes the capacitance of the all-pass filter 141. As it is understood from Equation (4), the phase rotation degree Δθₙ(f) of the all-pass filter 141 is different depending on the frequency f of a signal; therefore, different phase rotation may be applied to each frequency component of a transmission signal. Furthermore, by properly setting the effective resistance R_{eff,n} of the all-pass filter 141, different phase rotation is applied to each frequency component, including the center frequency of a transmission signal and a frequency at the edge of the signal bandwidth, so that it is possible to compensate for a phase shift due to a frequency width from the center frequency.

Furthermore, in the same manner as the above Equation (2), the following Equation (5) represents the phase shift Δϕₙ(f) of the nth antenna with regard to the frequency component at the frequency f of the baseband signal.

$$Δ {φ}_{n} ( f ) = \frac{2 π fnd}{C} sin {θ}_{0} \qquad ( 5 )$$

Furthermore, if the effective resistance R_{eff,n} is determined from Equations (4), (5) such that the phase shift Δϕₙ(f) is canceled by the phase rotation degree Δθ(f) of the all-pass filter 141, the above Equation (3) is obtained. Thus, the effective-resistance calculating unit 114 calculates the effective resistance R_{eff,n} to compensate for the phase shift that occurs in accordance with a frequency width from the center frequency of the transmission signal.

The effective-resistance setting unit 115 sets the effective resistance of each of the all-pass filters 141, calculated by the effective-resistance calculating unit 114, in each of the all-pass filters 141.

The phase control unit 116 calculates the phase value of each antenna to point a beam in the beam direction, determined by the beam-direction determining unit 112, and sets the calculated phase value in the phase shifter 142, which is provided in relation to each antenna.

The all-pass filter 141 is provided in relation to each of the antennas in a sub array, and it passes the entire band of a transmission signal for each antenna, output from the D/A converter 130. Here, the all-pass filter 141 applies phase rotation to each frequency component of a transmission signal in accordance with the effective resistance that is set by the effective-resistance setting unit 115. Conversely, the all-pass filter 141 does not change the amplitude of a transmission signal. That is, the all-pass filter 141 applies phase rotation to compensate for a phase shift that occurs due to the signal bandwidth of a transmission signal.

The phase shifter 142 is provided in relation to each of the antennas in a sub array, and it applies the phase value, set by the phase control unit 116, to a transmission signal for each antenna. A transmission signal is transmitted with large gain in the beam direction, determined by the beam-direction determining unit 112, due to the weight that is multiplied by the transmission-signal generating unit 113 and the phase value that is applied by the phase shifter 142.

The wireless processing unit 143 is provided in relation to each of the antennas in a sub array, and it performs predetermined wireless transmission processing on a transmission signal for each antenna. Specifically, the wireless processing unit 143 up-converts a transmission signal into a radio frequency to amplify it and then transmits it via each antenna.

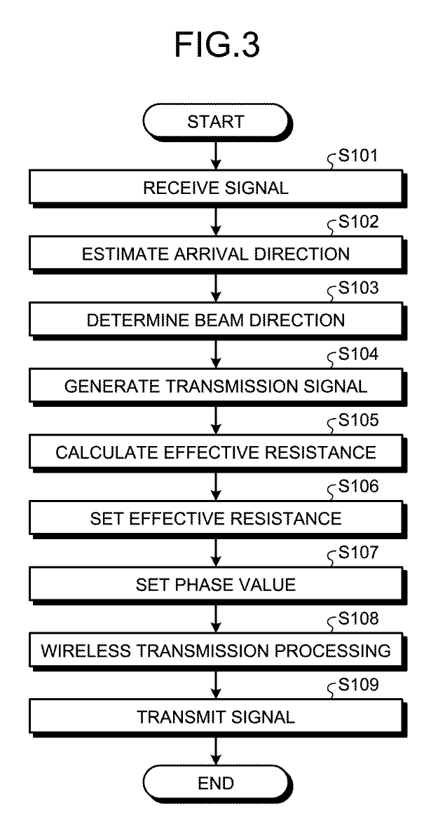

Next, with reference to the flowchart that is illustrated in FIG. 3, an explanation is given of a phase adjusting method by the base station device 100 that is configured as described above.

Prior to transmission of a signal from the base station device 100, a signal is received from the user terminal device, which is the other end of the communication (Step S101). For example, the signal may be transmitted by the user terminal device in accordance with a request from the base station device 100, or it may be transmitted by the user terminal device on a regular basis.

The reception signal is subjected to A/D conversion by the A/D converter 150 and is then output to the processor 110 so that the direction-of-arrival estimating unit 111 estimates the arrival direction of the reception signal (Step S102). As the arrival direction of the reception signal is the direction in which the user terminal device, which is the transmission destination of the signal, is located, the beam-direction determining unit 112 determines the beam direction on the basis of the arrival direction (Step S103). That is, it is determined that the direction of the user terminal device is the beam direction.

After the beam direction is determined, the transmission-signal generating unit 113 generates a transmission signal (Step S104) so that the transmission signal is multiplied by the weight that corresponds to the beam direction. That is, the transmission-signal generating unit 113 conducts digital-type beamforming. The transmission signal, which has been multiplied by the weight, is subjected to D/A conversion by the D/A converter 130 and is then output to the sub-array processing unit 140.

Furthermore, after the beam direction is determined, the effective-resistance calculating unit 114 calculates the effective resistance of the all-pass filter 141 on the basis of the beam direction (Step S105). Specifically, according to the above Equation (3), the effective resistance R_{eff,n} of the all-pass filter 141 for each antenna is calculated in accordance with the signal bandwidth BW and the beam direction θ₀. Then, the calculated effective resistance of each of the all-pass filters 141 is set in each of the all-pass filters 141 by the effective-resistance setting unit 115 (Step S106). Thus, the phase rotation degree in each of the all-pass filters 141 is set to a phase rotation degree to compensate for a phase shift of each frequency component that occurs due to the signal bandwidth of a transmission signal.

Furthermore, after the beam direction is determined, the phase control unit 116 calculates the phase value of each antenna to increase gain in a beam direction. Then, the phase control unit 116 sets the calculated phase value in the phase shifter 142 that corresponds to each antenna (Step S107). That is, the phase control unit 116 conducts analog-type beamforming.

After the effective resistance is set in the all-pass filter 141 and the phase value is set in the phase shifter 142, the transmission signal, output from the D/A converter 130, is bifurcated into a transmission signal for each antenna and is input to the all-pass filter 141. Then, the all-pass filter 141 applies phase rotation, which corresponds to the effective resistance, to the transmission signal for each antenna. That is, phase rotation is applied to each frequency component of a transmission signal so as to compensate for the phase shift that corresponds to the frequency width from the center frequency. Here, the amplitude of the transmission signal is not changed.

The phase shifter 142 applies a phase value to the transmission signal, which has passed through the all-pass filter 141. Specifically, the phase values, which have a phase difference that corresponds to a beam direction between adjacent antennas, are applied to transmission signals for antennas, whereby gain in the beam direction is maximized. This forms a beam that has the maximum gain in the direction of the user terminal device, which is the other end of the communication. Here, the phase shift of a transmission signal for each antenna is compensated by the all-pass filter 141; therefore, with regard to any frequency component in the signal bandwidth of the transmission signal, the beam direction matches the direction of the user terminal device, which is the other end of the communication.

The wireless processing unit 143 performs wireless transmission processing on the transmission signal, to which the phase value has been applied by the phase shifter 142 (Step S108). Specifically, the transmission signal is up-converted into a radio frequency and is amplified by an amplifier. Then, the transmission signal is transmitted through each antenna (Step S109). As a phase value is applied to a transmission signal, transmitted through each antenna, by the phase shifter 142, there is a phase difference between adjacent antennas. Due to the phase difference, the transmission signal is transmitted with large gain in the direction of the user terminal device, which the other end of the communication.

As described above, according to the present embodiment, an all-pass filter, which applies phase rotation, corresponding to the effective resistance, to an input signal, is provided for each of the antennas, and the effective resistance of the all-pass filter, which corresponds to each antenna, is calculated on the basis of the beam direction. Then, the calculated effective resistance is set in each of the all-pass filters, and phase rotation is applied to a transmission signal for each antenna by the all-pass filter. Therefore, phase rotation is conducted on each frequency component of a transmission signal to compensate for the phase shift that corresponds to a frequency width from the center frequency and, even if the signal bandwidth of a transmission signal is a wide band, it is possible to prevent degradations in the communication quality due to phase shifts during beamforming.

### [b] Second Embodiment

A second embodiment is characterized in that the effective resistance of an all-pass filter is determined to compensate for a frequency characteristic in an analog circuit in addition to a phase shift due to a frequency width from the center frequency.

As the configuration of the base station device according to the second embodiment is the same as that in the first embodiment (FIG. 1), its explanation is omitted. According to the second embodiment, the function of the processor 110 is different from that in the first embodiment.

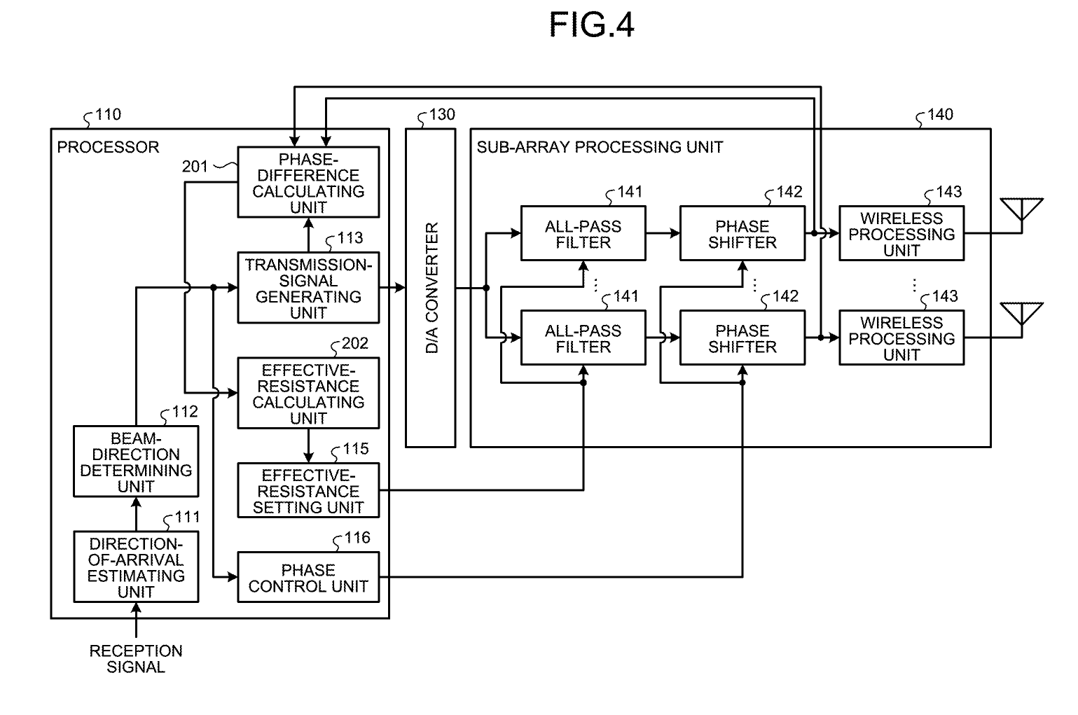

FIG. 4 is a block diagram that illustrates a configuration of a transmission section of the base station device 100 according to the second embodiment. In FIG. 4, the same component as that in FIG. 2 is attached with the same reference numeral, and its explanation is omitted. The processor 110, illustrated in FIG. 4, includes a phase-difference calculating unit 201 and an effective-resistance calculating unit 202 instead of the effective-resistance calculating unit 114 of the processor 110, illustrated in FIG. 2.

The phase-difference calculating unit 201 calculates a phase difference between the transmission signal generated by the transmission-signal generating unit 113 and the transmission signal output from the phase shifter 142. That is, the phase-difference calculating unit 201 calculates a phase difference that occurs in the passage route of a transmission signal within the base station device 100. Specifically, the phase difference that occurs in the passage route includes phase changes, which occur due to frequency characteristics of an analog circuit, included in the sub-array processing unit 140, and phase shifts due to a frequency width from the center frequency. A phase shift due to a frequency width from the center frequency is Δϕₙ(f) that is represented by the above Equation (5); therefore, if the frequency characteristic of the analog circuit is F(f), the phase difference ϕₙ(f) calculated by the phase-difference calculating unit 201 is represented by the following Equation (6).

ϕₙ(f)=angle[F(f)exp{jΔϕₙ(f)}] (6)

The analog circuit, included in the sub-array processing unit 140, includes the all-pass filter 141, the phase shifter 142, and the like; therefore, the phase difference ϕₙ(f) includes phase changes in the all-pass filter 141 and the phase shifter 142.

The effective-resistance calculating unit 202 calculates the effective resistance of the all-pass filter 141, which minimizes the phase difference that is calculated by the phase-difference calculating unit 201. Specifically, the effective-resistance calculating unit 202 calculates the effective resistance R_{eff,n} of the all-pass filter 141 that corresponds to the nth antenna, as in the following Equation (7).

$${R}_{eff , n} = arg {min}_{{R}_{eff , n}} {\sum }_{f = \frac{BW}{2}}^{\frac{BW}{2}} {\vert {φ}_{n} ( f ) + Δ {θ}_{n} ( f ) \vert}^{2} \qquad ( 7 )$$

Specifically, the effective-resistance calculating unit 202 calculates the effective resistance that causes the sum of the phase difference, calculated by the phase-difference calculating unit 201, and the phase rotation degree of the all-pass filter 141 to be near zero with regard to the entire signal bandwidth BW where the center frequency of the baseband signal is 0. Therefore, by setting the calculated effective resistance in the all-pass filter 141, it is possible to compensate for the frequency characteristic of the analog circuit and the phase shift that corresponds to a frequency width from the center frequency.

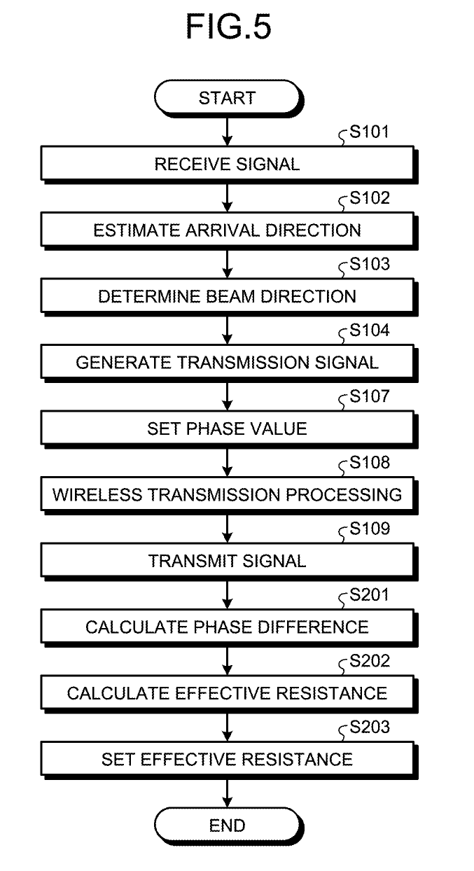

Next, with reference to the flowchart illustrated in FIG. 5, an explanation is given of a phase adjusting method by the base station device 100 that is configured as described above. In FIG. 5, the same component as that in FIG. 3 is attached with the same reference numeral, and its detailed explanation is omitted.

Prior to transmission of a signal from the base station device 100, a signal is received from the user terminal device, which is the other end of the communication (Step S101). The reception signal is subjected to A/D conversion by the A/D converter 150 and is then output to the processor 110 so that the direction-of-arrival estimating unit 111 estimates the arrival direction of the reception signal (Step S102), and the beam-direction determining unit 112 determines the beam direction on the basis of the arrival direction (Step S103). After the beam direction is determined, the transmission-signal generating unit 113 generates a transmission signal (Step S104) so that the transmission signal is multiplied by the weight that corresponds to the beam direction.

Furthermore, after the beam direction is determined, the phase control unit 116 calculates the phase value for each antenna and sets the calculated phase value in the phase shifter 142 that corresponds to each antenna (Step S107). Moreover, at this point, the effective resistance, which is set in all the all-pass filters 141, causes the phase rotation degree, applied to the all-pass filter 141, to be 0.

Then, the transmission signal, output from the D/A converter 130, is bifurcated into a transmission signal for each antenna to pass through the all-pass filter 141, and is attached with the phase value by the phase shifter 142. This forms a beam that has the maximum gain in the direction of the user terminal device, which is the other end of the communication. The transmission signal, to which the phase value has been applied by the phase shifter 142, is subjected to wireless transmission processing by the wireless processing unit 143 (Step S108), and it is transmitted through each antenna (Step S109).

Furthermore, the phase-difference calculating unit 201 calculates a phase difference between the transmission signal generated by the transmission-signal generating unit 113 and the transmission signal output from each of the phase shifters 142 (Step S201). The phase difference calculated here is a phase difference that includes a phase shift that occurs due to the frequency characteristic of the analog circuit and a phase shift that corresponds to a frequency width from the center frequency, and the phase difference is to be compensated. Therefore, the effective-resistance calculating unit 202 calculates the effective resistance to minimize the phase difference, which is calculated by the phase-difference calculating unit 201, according to the above Equation (7) (Step S202). Then, the effective-resistance setting unit 115 sets the calculated effective resistance of each of the all-pass filters 141 in each of the all-pass filters 141 (Step S203). Thus, the phase rotation degree, set in each of the all-pass filters 141, is a phase rotation degree to compensate for the frequency characteristic of the analog circuit and the phase shift of each frequency component, which occurs due to the signal bandwidth of the transmission signal.

Afterward, the transmission signal for each antenna is passed through the all-pass filter 141 so as to be given the phase rotation to compensate for the frequency characteristic of the analog circuit and the phase shift that corresponds to the frequency width from the center frequency.

As described above, according to the present embodiment, each of the antennas is provided with an all-pass filter that applies phase rotation, which corresponds to the effective resistance, to an input signal, and the effective resistance is calculated, which minimizes a phase shift that occurs in the transmission signal. Then, the calculated effective resistance is set in each all-pass filter, and phase rotation is applied to a transmission signal for each antenna by the all-pass filter. Thus, phase rotation is conducted on each frequency component of a transmission signal to compensate for the frequency characteristic of the analog circuit and the phase shift that corresponds to a frequency width from the center frequency and, even if the signal bandwidth of a transmission signal is a wide band, it is possible to prevent degradations in the communication quality due to phase shifts during beamforming.

Furthermore, the first embodiment and the second embodiment, described above, may be combined for implementation. Specifically, after the effective resistance of the all-pass filter 141 is calculated and set on the basis of the beam direction according to the first embodiment, the effective resistance may be corrected to minimize the phase difference between the generated transmission signal and the transmission signal output from the phase shifter 142 according to the second embodiment. Thus, it is possible to compensate for phase shifts that occur due to the frequency characteristic of the analog circuit after the effective resistance is set on the basis of the beam direction.

Furthermore, although the all-pass filter applies phase rotation to a transmission signal for each antenna according to each of the above-described embodiments, a different phase adjusting member may apply phase rotation to a transmission signal. Specifically, if a phase adjusting member is capable of changing the phase rotation degree, which is applied to a transmission signal, by setting a parameter, a member other than the all-pass filter may be used. However, as it is preferable that the amplitude of a transmission signal is not changed when phase rotation is applied, it is preferable to use an all-pass filter. Furthermore, the phase adjusting member, such as an all-pass filter, does not need to be provided at the former stage of the phase shifter. That is, a sub-array processing unit may be configured such that, for example, the all-pass filter is provided at the subsequent stage of the phase shifter.

Furthermore, although hybrid-type beamforming is explained in each of the above-described embodiments, phase shifts may be compensated by using an all-pass filter during full-analog type beamforming.

According to one aspect of the communication control device and the phase adjusting method, disclosed in the subject application, there is an advantage such that it is possible to prevent degradations in the communication quality due to phase shifts during beamforming.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control device comprising:
a beam forming unit that forms a beam by controlling a phase of a transmission signal that is transmitted through each of a plurality of antennas;
a phase adjusting unit that applies phase rotation to the transmission signal to compensate for a phase shift at each frequency of the transmission signal, whose phase is controlled by the beam forming unit, the phase shift corresponding to a signal bandwidth of the transmission signal; and
a control unit that controls the phase rotation that is applied to the transmission signal by the phase adjusting unit.

2. The communication control device according to claim 1, wherein
the phase adjusting unit includes a plurality of all-pass filters that are provided in relation to the antennas and that apply the phase rotation corresponding to effective resistance to the transmission signal, and
the control unit determines the effective resistance of the all-pass filters to control the phase rotation.

3. The communication control device according to claim 2, wherein the control unit includes
a calculating unit that calculates the effective resistance of the all-pass filters in accordance with a direction of the beam formed by the beam forming unit; and
a setting unit that sets the effective resistance calculated by the calculating unit in each of the all-pass filters.

4. The communication control device according to claim 2, wherein
the control unit includes
a phase-difference calculating unit that calculates a phase difference that occurs in the transmission signal on a passage route within the communication control device;
an effective-resistance calculating unit that calculates the effective resistance of the all-pass filters which minimizes the phase difference calculated by the phase-difference calculating unit; and
a setting unit that sets the effective resistance calculated by the effective-resistance calculating unit in each of the all-pass filters.

5. A phase adjusting method for a communication control device that performs beamforming by controlling a phase of a transmission signal that is transmitted through each of a plurality of antennas, the phase adjusting method comprising:
controlling phase rotation that is applied to the transmission signal at a phase adjusting unit; and
applying the controlled phase rotation to the transmission signal at the phase adjusting unit to compensate for a phase shift at each frequency of the transmission signal, whose phase is controlled during the beamforming, the phase shift corresponding to a signal bandwidth of the transmission signal.
